(19) United States
(12) Patent Application Publication
(10) Pub. No.: US 2021/0262974 A1
(43) Pub. Date: Aug. 26, 2021

(54) GAS SENSOR

(71) Applicant: DENSO CORPORATION, Kariya-city (JP)

(72) Inventors: Toshihiko HARADA, Nisshin-city (JP); Kensuke TAKIZAWA, Kariya-city (JP); Hiroki ICHIKAWA, Kariya-city (JP)

(21) Appl. No.: 17/319,428

(22) Filed: May 13, 2021

Related U.S. Application Data
(63) Continuation of application No. PCT/JP2019/043175, filed on Nov. 4, 2019.

(30) Foreign Application Priority Data
Nov. 15, 2018 (JP) 2018-214827

(51) Int. Cl. G01N 27/406; G01N 27/407

(52) U.S. Cl. CPC G01N 27/4067; G01N 27/407

(57) ABSTRACT

A gas sensor includes an ammonia element section, a heater, and a potential difference detecting section. The detection electrode has a distal end, a proximal end, and a central position in the longitudinal direction. The detection electrode is partitioned at the central position in the longitudinal direction into a distal end region and a proximal end region, the distal end region being located to be closer to the distal end than the proximal end region is, the proximal end region being located to be closer to the proximal end than the distal end region is. The heating section has a heating center arranged to face an offset point which is located to be closer to the distal end than the central position is, the heating center arranged to face the offset point causing average temperature in the distal end region to differ from average temperature in the proximal end region.

### CROSS-REFERENCE TO RELATED APPLICATION

The present application is a continuation application of International Application No. PCT/JP2019/043175, filed on Nov. 4, 2019, which claims priority to Japanese Patent Application No. 2018-214827, filed on Nov. 15, 2018. The contents of these applications are incorporated herein by reference in their entirety.

### BACKGROUND

### Technical Field

The present disclosure relates to a gas sensor including a detection element.

### Background Art

For example, vehicles include a catalyst for purifying NOx (nitrogen oxides), such as NO and NO₂, in exhaust gas that is exhausted from an internal combustion engine, which is a diesel engine for example. The catalyst is located in an exhaust pipe. To reduce NOx, a selective catalytic reduction (SCR), which is a type of catalyst, causes ammonia (NH₃) included in, for example, an aqueous urea solution to adhere to a catalyst carrier, so that ammonia and NOx causes a chemical reaction on the catalyst carrier, thereby reducing NOx to nitrogen (N₂) and water (H₂O).

Additionally, a reducing agent supplying device, which supplies a reducing agent, which is ammonia in this case, to the selective catalytic reduction, is located upstream of the selective catalytic reduction in the exhaust pipe in the direction of the flow of the exhaust gas. Furthermore, for example, a NOx sensor, which detects the concentration of NOx in the exhaust gas, and an ammonia sensor, which detects the concentration of ammonia in the exhaust gas, are located downstream of the selective catalytic reduction in the exhaust pipe in the direction of the flow of the exhaust gas. By detecting the amount of NOx and ammonia using the NOx sensor and the ammonia sensor, the purification efficiency of NOx using ammonia is improved while the leakage of ammonia from the selective catalytic reduction is inhibited.

### SUMMARY

In the present disclosure, provided is a gas sensor as the following.

The gas sensor including a detection element section, a heater, and a potential difference detecting section. The detection electrode has a distal end, a proximal end, and a central position in the longitudinal direction. The detection electrode is partitioned at the central position in the longitudinal direction into a distal end region and a proximal end region, the distal end region being located to be closer to the distal end than the proximal end region is, the proximal end region being located to be closer to the proximal end than the distal end region is. The heating section has a heating center arranged to face an offset point, the offset point being located to be closer to one of the distal end and the proximal end of the detection electrode than the central position is, the heating center arranged to face the offset point causing a first average temperature in the distal end region of the detection electrode in the longitudinal direction to differ from a second average temperature in the proximal end region of the detection electrode in the longitudinal direction.

### BRIEF DESCRIPTION OF THE DRAWINGS

The object, features, advantages, and the like of the present disclosure will become more apparent by the following detailed description with reference to the accompanying drawings in which:

FIG. 1 is a cross-sectional explanatory diagram illustrating the configuration of a gas sensor according to a first embodiment;

FIG. 2 is a cross-sectional view taken along line II-II of FIG. 1 illustrating a sensor element according to the first embodiment;

FIG. 3 is a cross-sectional view taken along line of FIG. 1 illustrating the sensor element according to the first embodiment;

FIG. 4 is a diagram corresponding to the cross-section taken along line of FIG. 1 illustrating another sensor element according to the first embodiment;

FIG. 5 is a cross-sectional view taken along line V-V of FIG. 1 illustrating the sensor element according to the first embodiment;

FIG. 6 is an explanatory diagram showing the electrical configuration involved in detecting the concentration of ammonia in a sensor control unit according to the first embodiment;

FIG. 7 is an explanatory diagram illustrating the state in which the gas sensor is located in an internal combustion engine according to the first embodiment;

FIG. 8 is an explanatory diagram showing a mixed potential generated in a detection electrode according to the first embodiment;

FIG. 9 is an explanatory diagram showing the mixed potential generated in the detection electrode when the concentration of ammonia is changed according to the first embodiment;

FIG. 10 is an explanatory diagram showing the mixed potential generated in the detection electrode when the concentration of oxygen is changed according to the first embodiment;

FIG. 11 is an explanatory diagram showing the mixed potential generated in the detection electrode when the temperature of the detection electrode is changed according to the first embodiment;

FIG. 12 is a graph showing the relationship between the temperature of the detection electrode and the correction amount of the potential difference according to the first embodiment;

FIG. 13 is an explanatory diagram showing the mixed potential generated in the detection electrode in a case in which measurement gas includes other gases such as CO and C₃H₈ according to the first embodiment;

FIG. 14 is a graph showing the relationship between the ammonia concentration and the potential difference when the oxygen concentration is changed according to the first embodiment;

FIG. 15 is a graph showing the relationship between the potential difference and the ammonia concentration after oxygen correction according to the first embodiment;

FIG. 16 is a diagram corresponding to the cross-section taken along line of FIG. 1 illustrating a sensor element according to a second embodiment;

FIG. 17 is a diagram corresponding to the cross-section taken along line of FIG. 1 illustrating another sensor element according to the second embodiment;

FIG. 18 is a cross-sectional explanatory diagram illustrating the configuration of a gas sensor according to a third embodiment;

FIG. 19 is a cross-sectional view taken along line XIX-XIX of FIG. 18 illustrating a sensor element according to the third embodiment;

FIG. 20 is a cross-sectional explanatory diagram illustrating a sensor element according to a fourth embodiment;

FIG. 21 is a cross-sectional view taken along line XXI-XXI of FIG. 20 illustrating the configuration of a gas sensor according to the fourth embodiment;

FIG. 22 is a graph showing the relationship between the temperature of a detection electrode and a sensor output according to Verification Test 1;

FIG. 23 is a graph showing the relationship between the temperature of the detection electrode and the response time of the sensor output according to Verification Test 1; and

FIG. 24 is a graph showing changes in the average temperature in the distal end region and the proximal end region of the detection electrode when a state is changed from a normal state to a transient state according to Verification Test 2.

### DETAILED DESCRIPTION OF THE PREFERRED EMBODIMENTS

For example, PTL1 discloses a multi-gas sensor including a NOx sensor unit, which detects the current corresponding to the NOx concentration, and an ammonia sensor unit, which is formed on the outer surface of the NOx sensor unit. The multi-gas sensor is capable of measuring the NOx concentration and the ammonia concentration by a single gas sensor.

[PTL 1] JP 2010-38806 A

In the ammonia sensor, the sensitivity to ammonia is likely to increase as the temperature of an electrode for detecting ammonia on a solid electrolyte approaches a temperature as low as about 400° C. Additionally, in the ammonia sensor, the sensitivity of the electrode to ammonia is likely to increase by facilitating the electrode to come into contact with gas to be detected that includes ammonia. Thus, in the multi-gas sensor of PTL 1, the ammonia sensor unit is located on the outer section of the ammonia sensor, and the temperature of the ammonia sensor unit is controlled to be approximately 400° C.

However, if the gas to be detected is made to easily abut against the ammonia sensor unit, and the temperature of the ammonia sensor unit is controlled to a low temperature, the following problem arises. That is, for example, if the flow rate of the gas to be detected suddenly fluctuates, the ammonia sensor unit is rapidly cooled, which may decrease the temperature of the ammonia sensor to a temperature further below approximately 400° C. This may possibly decrease the temperature of the ammonia sensor unit to be lower than the operating temperature. In this case, the detection accuracy of the multi-gas sensor of PTL 1 in detecting the ammonia concentration may possibly deteriorate.

The present disclosure is achieved in an attempt to provide a gas sensor that accurately detects the concentration of a specific gas component in gas to be detected in both a normal state and a transient state.

One aspect of the present disclosure provides a gas sensor including:

a detection element section that has an elongated shape in a longitudinal direction, and includes a solid electrolyte with oxygen-ion conductivity, a detection electrode which is located on a surface of the solid electrolyte and is exposed to gas to be detected, and a reference electrode located on the surface of the solid electrolyte;

a heater that includes a heating section that generates heat by energization, the heater being configured to heat the solid electrolyte, the detection electrode, and the reference electrode based on the heat generated by the heating section; and

a potential difference detecting section that detects a potential difference between the detection electrode and the reference electrode, the potential difference being caused as a mixed-potential between the detection electrode and the reference electrode when an electrochemical reduction reaction of oxygen contained in the gas to be detected and an electrochemical oxidation reaction of ammonia contained in the gas to be detected are balanced in the detection electrode,

the detection electrode has a distal end, a proximal end, and a central position in the longitudinal direction;

the detection electrode is partitioned at the central position in the longitudinal direction into a distal end region and a proximal end region, the distal end region being located to be closer to the distal end than the proximal end region is, the proximal end region being located to be closer to the proximal end than the distal end region is; and

the heating section has a heating center arranged to face an offset point,

the offset point being located to be closer to one of the distal end and the proximal end of the detection electrode than the central position is, the heating center arranged to face the offset point causing a first average temperature in the distal end region of the detection electrode in the longitudinal direction to differ from a second average temperature in the proximal end region of the detection electrode in the longitudinal direction.

In the gas sensor according to one aspect, the positional relationship between the detection electrode and the heating section of the heater is designed so that the temperature of the detection electrode differs between the distal end region and the proximal end region in the longitudinal direction. More specifically, the heating center is arranged to face an offset point, the offset point is located to be closer to one of the distal end and the proximal end of the detection electrode than the central position is. In this manner, the average temperature in the distal end region of the detection electrode in the longitudinal direction and the average temperature in the proximal end region of the detection electrode in the longitudinal direction are intentionally set to be different.

With this configuration, for example, one of the distal end region and the proximal end region of the detection electrode is set to an operating temperature that activates the catalytic activity or to an appropriate temperature at which the sensitivity to the specific gas component is excellent. The other one of the distal end region and the proximal end region is set to a temperature higher than the operating temperature or a temperature higher than the appropriate temperature. In the normal state of the gas sensor, the sensitivity to the specific gas component is maintained in the region that is controlled to the operating temperature or the appropriate temperature. Furthermore, in the transient state in which the temperature of the gas sensor (detection element) is suddenly decreased due to, for example, decrease in the temperature of the gas to be detected or increase in the flow rate, while the temperature of one of the regions is decreased to be lower than the operating temperature or the appropriate temperature, the temperature of the other region is at the operating temperature or the appropriate temperature.

This maintains at least one of the distal end region and the proximal end region of the detection electrode at the operating temperature or the appropriate temperature in both the normal state and the transient state. Consequently, the gas sensor according to one aspect accurately detects the concentration of the specific gas component in the gas to be detected in both the normal state and the transient state.

The detection electrode is partitioned at the central position in the longitudinal direction into a distal end region and a proximal end region, the distal end region is located to be closer to the distal end than the proximal end region is, the proximal end region is located to be closer to the proximal end than the distal end region is. Furthermore, “the average temperature in the distal end region” is the mean of the average value of the temperatures of multiple sections in the distal end region, and “the average temperature in the proximal end region” is the mean of the average value of the temperatures of multiple sections in the proximal end region.

Reference signs in parentheses given to components in one aspect of the present disclosure indicate the correspondence to reference signs in the drawing of the embodiment and do not limit the components to only the contents of the embodiment.

The gas sensor according to preferred embodiments described above will be described with reference to the drawings.

### First Embodiment

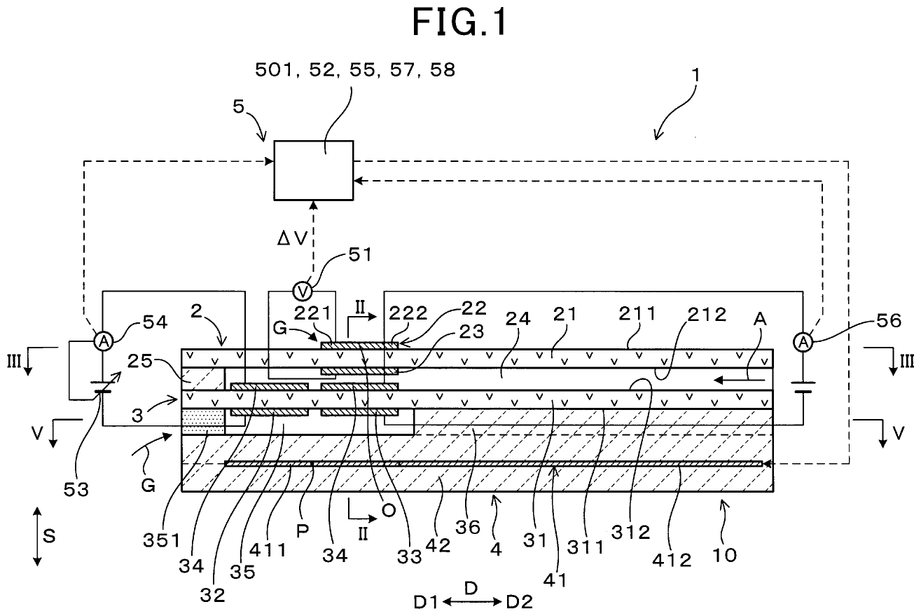

As shown in FIGS. 1 to 3 and 5, a gas sensor 1 according to the present embodiment includes a detection element section, which is an ammonia element section 2 in the present embodiment, a heater 4, and a potential difference detecting section 51. The ammonia element section 2 and the heater 4 constitute part of a sensor element 10. The ammonia element section 2 includes an oxygen-ion conductive first solid electrolyte 21, a detection electrode (ammonia electrode) 22, which is located on a first surface 211 of the first solid electrolyte 21 and is exposed to gas to be detected G containing oxygen (O₂) and ammonia (NH₃), and a reference electrode 23, which is located on a second surface 212 of the first solid electrolyte 21 reverse from the first surface 211. The ammonia element section 2 has an elongated shape in a longitudinal direction D. The heater 4 includes a heating section 411, which generates heat upon energization, and heats the first solid electrolyte 21, the detection electrode 22, and the reference electrode 23 based on the heat generated by the heating section 411.

As shown in FIGS. 1 and 3, the potential difference detecting section 51 detects a potential difference ΔV between the detection electrode 22 and the reference electrode 23 generated when an electrochemical reduction reaction of oxygen contained in the gas to be detected G and an electrochemical oxidation reaction of a specific gas component, which is ammonia in the present embodiment, contained in the gas to be detected G, are balanced in the detection electrode 22. The detection electrode 22 has a distal end D1, a proximal end D2, and a central position O in the longitudinal direction. The heating section 411 has a heating center P arranged to face an offset point, the offset point is located to be closer to the distal end D1 of the detection electrode than the central position O is, the heating center P arranged to face the offset point causing the average temperature in a distal end region 221 of the detection electrode 22 in the longitudinal direction D to differ from the average temperature in a proximal end region 222 of the detection electrode 22 in the longitudinal direction D.

The gas sensor 1 of the present embodiment will be described in detail below.

(Gas Sensor 1)

As shown in FIG. 1, the gas sensor 1 of the present embodiment is a potential-difference sensor, which is a mixed-potential sensor in the present embodiment. The gas sensor 1 detects the concentration of ammonia in the gas to be detected G, which contains oxygen and ammonia. The gas sensor 1 constitutes an ammonia sensor. The potential difference detecting section 51 of the present embodiment detects the potential difference ΔV between the detection electrode 22 and the reference electrode 23 generated when a reduction current caused by an electrochemical reduction reaction of oxygen (hereinafter, simply referred to as the reduction reaction) and an oxidation current caused by an electrochemical oxidation reaction of ammonia (hereinafter, simply referred to as the oxidation reaction) are equal on the detection electrode 22.

Note that, the detection electrode 22 of the sensor element 10 of the gas sensor 1 may detect various specific gas components besides ammonia using a mixed potential. For example, the detection electrode 22 may detect CO (carbon monoxide), NO (nitrogen monoxide), NO₂ (nitrogen dioxide), N₂O (nitrous oxide), H₂ (hydrogen), H₂O (water), and HC (hydrocarbon such as CH₄, C₂H₆, C₃H₈, C₄H₁₀, C₂H₄, C₃H₆, C₄H₈, and C₂H₂) using the mixed potential.

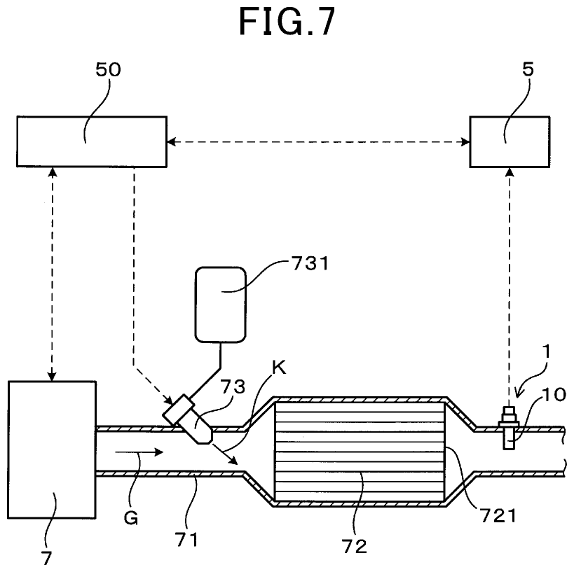

As shown in FIG. 7, the gas sensor 1 detects the concentration of ammonia that flows out from a catalyst 72, which reduces NOx, in an exhaust pipe 71 of an internal combustion engine (engine) 7 of a vehicle. The gas to be detected G is exhaust gas exhausted from the internal combustion engine 7 to the exhaust pipe 71. The composition of the exhaust gas is changed in accordance with the combustion state of the internal combustion engine 7. If the mass ratio of air and fuel, which is the air-fuel ratio, in the internal combustion engine 7 is in a fuel-rich state compared to the stoichiometric air-fuel ratio, the ratio of NOx (nitrogen oxides) such as NO, NO₂, and N₂O is decreased while the ratio of, for example, HC (hydrocarbon), CO (carbon monoxide), and H₂ (hydrogen) contained in unburnt gas is increased as the composition of the exhaust gas. If the air-fuel ratio of the internal combustion engine 7 is in a fuel-lean state compared to the stoichiometric air-fuel ratio, the ratio of NOx is increased while the ratio of, for example, HC and CO is decreased as the composition of the exhaust gas. Furthermore, in a fuel-rich state, little oxygen (air) is contained in the gas to be detected G, and in a fuel-lean state, oxygen (air) is contained in the gas to be detected G by a larger amount.

(Catalyst 72)

As shown in FIG. 7, the exhaust pipe 71 is provided with the catalyst 72, which reduces NOx, and a reducing agent supplying device 73, which supplies a reducing agent K containing ammonia to the catalyst 72. The catalyst 72 includes a catalyst carrier on which the reducing agent K for reducing NOx will adhere. The reducing agent K is ammonia in the present embodiment. The amount of ammonia adhered to the catalyst carrier of the catalyst 72 is decreased in accordance with the reduction reaction of NOx. When the amount of ammonia adhered to the catalyst carrier is reduced, ammonia is additionally supplied to the catalyst carrier from the reducing agent supplying device 73. The reducing agent supplying device 73 is located in the exhaust pipe 71 upstream of the catalyst 72 in the direction of the flow of the exhaust gas and supplies ammonia gas generated by spraying an aqueous urea solution to the exhaust pipe 71. The ammonia gas is generated by hydrolyzation of the aqueous urea solution. A tank 731 for the aqueous urea solution is connected to the reducing agent supplying device 73.

The internal combustion engine 7 of the present embodiment is a diesel engine that performs combustion using autoignition of light oil. The catalyst 72 is a selective catalytic reduction (SCR) that causes NOx (nitrogen oxides) to chemically react with ammonia (NH₃) to reduce NOx to nitrogen (N₂) and water (H₂O).

Although not shown, components such as an oxidation catalyst (DOC), which converts (oxidizes) NO to NO₂ and reduces, for example, CO and HC (hydrocarbon), and a filter (DPF), which collects fine particles, may be located upstream of the catalyst 72 in the exhaust pipe 71.

(Multi-Gas Sensor)

As shown in FIG. 7, the gas sensor 1 of the present embodiment is located downstream of the catalyst 72 in the exhaust pipe 71. In a precise sense, the sensor body including the sensor element 10 is located in the exhaust pipe 71, and a sensor control unit (SCU) 5, which includes, for example, the potential difference detecting section 51, is disposed elsewhere. For convenience, the sensor body is sometimes referred to as the gas sensor 1 in the present embodiment.

The gas sensor 1 of the present embodiment is formed as a multi-gas sensor (compound sensor) capable of detecting the oxygen concentration and the NOx concentration in addition to the ammonia concentration. The gas sensor 1 uses the oxygen concentration to correct the ammonia concentration. Additionally, the ammonia concentration and the NOx concentration obtained by the gas sensor 1 are used for determining the point in time at which the reducing agent K, which is ammonia in the present embodiment, is supplied to the exhaust pipe 71 from the reducing agent supplying device 73 by a controller of the internal combustion engine 7. The controller is an engine control unit (ECU) 50.

The controller includes various electronic control units besides the engine control unit 50, which controls the engine, and the sensor control unit 5, which controls the gas sensor 1. The controller refers to various computers (processing devices).

If the gas sensor 1 detects the existence of NOx in the gas to be detected G, the engine control unit 50 detects that ammonia is insufficient in the catalyst 72 and sprays the aqueous urea solution from the reducing agent supplying device 73 to supply ammonia to the catalyst 72. If the gas sensor 1 detects the existence of ammonia in the gas to be detected G, the engine control unit 50 detects that the ammonia in the catalyst 72 is excessive and stops spraying the aqueous urea solution from the reducing agent supplying device 73 to stop supplying ammonia to the catalyst 72. The catalyst 72 preferably receives ammonia for reducing NOx without excess or deficiency.

Since the engine control unit 50 controls supply of ammonia, a state in which NOx is appropriately reduced by ammonia, a state in which the outflow of NOx is increased, and a state in which the outflow of ammonia is increased occur at a different point in time in the concentration region of NOx and ammonia in the gas to be detected G that exists downstream of the catalyst 72 (a catalyst outlet 721) and at a position where the gas sensor 1 is located.

(Sensor Body)

Although not shown, the sensor body of the gas sensor 1 includes the sensor element 10, which includes the heater 4 and detects the ammonia concentration and the NOx concentration, a housing that holds and mounts the sensor element 10 to the exhaust pipe 71, a distal end cover that is mounted on the distal end D1 of the housing and protects the sensor element 10, and a proximal end cover, which is mounted on a proximal end D2 of the housing and protects electrical wiring of the sensor element 10. As shown in FIGS. 1 to 3, a heating member 41, which constitutes the heater 4, is embedded in the sensor element 10.

(Sensor Element 10)

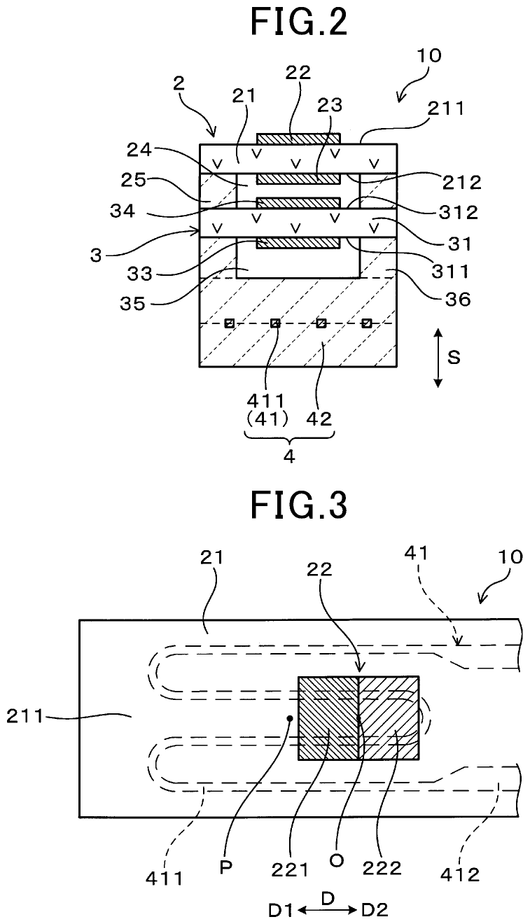

As shown in FIGS. 1 and 2, to constitute the multi-gas sensor, the sensor element 10 includes the ammonia element section 2 for detecting the ammonia concentration and an oxygen element section 3 for detecting the oxygen concentration and the NOx concentration. The sensor element 10 includes the first solid electrolyte 21 for forming the ammonia element section 2 and a second solid electrolyte 31 for forming the oxygen element section 3.

The first solid electrolyte 21 and the second solid electrolyte 31 are rectangular parallelepiped and shaped like a plate. Plate-like insulating bodies 25, 36, and 42 are laminated on the first solid electrolyte 21 and the second solid electrolyte 31. A reference gas duct 24 which accommodates the reference electrode 23 is formed on the insulating body 25 located between the first solid electrolyte 21 and the second solid electrolyte 31. The detection electrode 22 is located on the first surface 211, which is the outer surface of the first solid electrolyte 21. The first surface 211 forms the outer surface of the sensor element 10 and is exposed to the gas to be detected G. The first surface 211 of the first solid electrolyte 21 is the frontmost surface of the sensor element 10 and receives the gas to be detected G that collides at a predetermined flow rate.

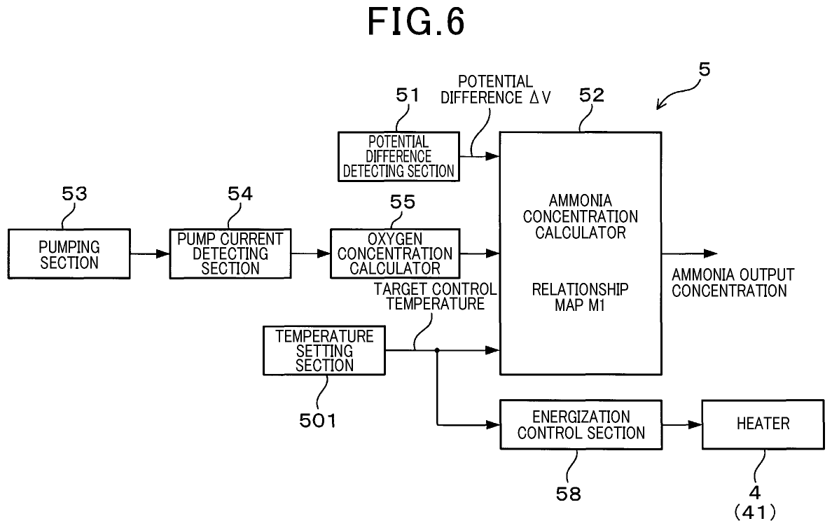

As shown in FIGS. 1 and 6, the gas sensor 1 of the present embodiment includes an ammonia concentration calculator 52 and a energization control section 58 in addition to the ammonia element section 2, the heater 4, and the potential difference detecting section 51. The ammonia concentration calculator 52 calculates the ammonia concentration of the gas to be detected G that has been corrected in accordance with the oxygen concentration based on the oxygen concentration of the gas to be detected G and the potential difference ΔV obtained by the potential difference detecting section 51. The energization control section 58 controls the energization amount to the heating member 41 so that the temperature of the detection electrode 22 becomes equal to a target control temperature within the range of 350 to 600° C. Additionally, as the target control temperature controlled by the energization control section 58 is increased, the ammonia concentration calculator 52 decreases the correction amount of the ammonia concentration when the oxygen concentration is changed by a predetermined amount. The heater 4 includes the heating member 41, which generates heat by energization.

(Ammonia Element Section 2)

As shown in FIGS. 1 and 2, the first solid electrolyte 21 is plate-shaped and is formed of a zirconia material that has the property of conducting oxygen ion at a predetermined temperature. The zirconia material may be formed of various kinds of material including zirconia as a main component. The zirconia material may be stabilized zirconia or partially stabilized zirconia in which some of zirconia is substituted by a rare-earth metal element such as yttria (yttrium oxide) or an alkaline-earth metal element.

The detection electrode 22 is formed of a noble metal material that contains gold (Au), which exhibits catalytic activity for ammonia and oxygen. The noble metal material of the detection electrode 22 may be formed of, for example, an alloy of platinum and gold, an alloy of platinum and palladium, or an alloy of palladium and gold. The reference electrode 23 is formed of a noble metal material such as platinum (Pt), which exhibits catalytic activity for oxygen. Furthermore, the detection electrode 22 and the reference electrode 23 may include a zirconia material that serves as common material used when the detection electrode 22 and the reference electrode 23 are sintered with the first solid electrolyte 21.

The first surface 211 of the first solid electrolyte 21 that is exposed to the gas to be detected G forms the outermost surface of the sensor element 10 of the gas sensor 1. The detection electrode 22 located on the first surface 211 is formed to easily come into contact with the gas to be detected G. A protection layer formed of, for example, a ceramic porous body is not provided on the surface of the detection electrode 22 of the present embodiment. The gas to be detected G comes into contact with the detection electrode 22 without diffusion limitation. A protection layer that, as much as possible, does not decrease the flow rate of the gas to be detected G may be provided on the surface of the detection electrode 22.

The reference electrode 23 provided on the second surface 212 of the first solid electrolyte 21 is exposed to a reference gas A, which is the atmospheric air in the present embodiment. The reference gas duct (atmospheric air duct) 24, which introduces the atmospheric air, is formed adjacent to the second surface 212 of the first solid electrolyte 21.

(Potential Difference Detecting Section 51 and Potential Difference ΔV)

As shown in FIG. 1, the potential difference detecting section 51 of the present embodiment detects the potential difference ΔV between the detection electrode 22 and the reference electrode 23 when a mixed potential occurs in the detection electrode 22. If ammonia and oxygen exist in the gas to be detected G, which comes into contact with the detection electrode 22, the oxidation reaction of ammonia and the reduction reaction of oxygen take place simultaneously in the detection electrode 22. The oxidation reaction of ammonia is typically represented by 2NH₃+3O²⁻→N₂+3H₂O+6e⁻. The reduction reaction of oxygen is typically represented by O₂+4e⁻→2O²⁻. The mixed potential caused by ammonia and oxygen in the detection electrode 22 occurs as the potential in a case where the oxidation reaction (speed) of ammonia and the reduction reaction (speed) of oxygen in the detection electrode 22 are equal.

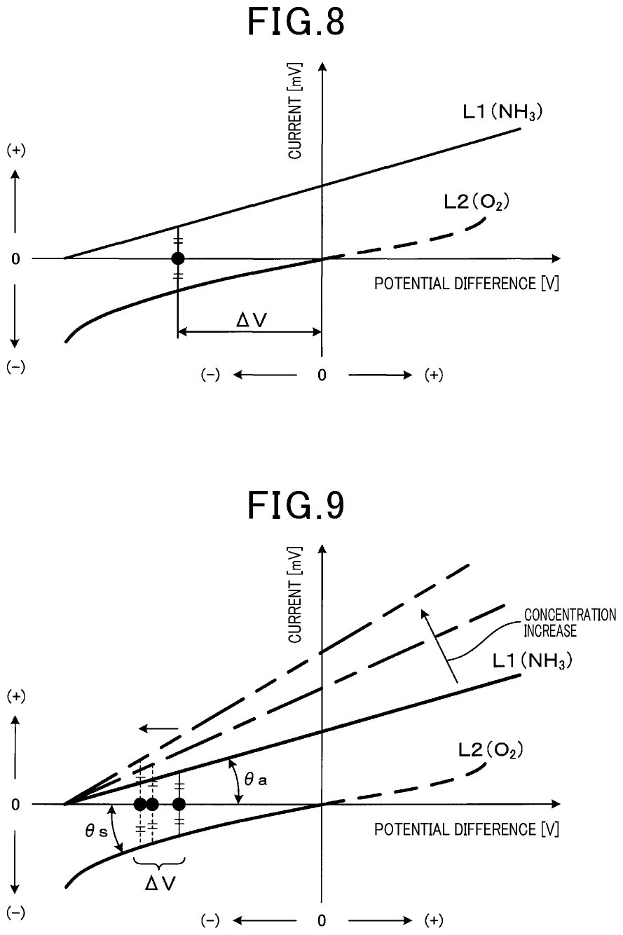

FIG. 8 is a diagram for explaining the mixed potential that occurs in the detection electrode 22. In FIG. 8, the horizontal axis represents the potential of the detection electrode 22 with respect to the reference electrode 23 (potential difference ΔV), and the vertical axis represents the current that flows across the detection electrode 22 and the reference electrode 23. FIG. 8 shows the manner in which the mixed potential changes. FIG. 8 shows a first line L1, which represents the relationship between the potential and the current when the oxidation reaction of ammonia takes place in the detection electrode 22, and a second line L2, which represents the relationship between the potential and the current when the reduction reaction of oxygen takes place in the detection electrode 22. The first line L1 and the second line L2 are both upward-sloping lines.

If the potential difference ΔV is 0 (zero), the potential of the detection electrode 22 is equal to the potential of the reference electrode 23. The mixed potential is the potential when the positive-side current on the first line L1, which represents the oxidation reaction of ammonia, is balanced with the negative-side current on the second line L2, which represents the reduction reaction of oxygen. The mixed potential in the detection electrode 22 is detected as the negative-side potential with respect to the reference electrode 23.

As shown in FIG. 9, if the ammonia concentration in the gas to be detected G is increased, the inclination θa of the first line L1, which represents the oxidation reaction of ammonia, becomes steeper. In this case, the potential at which the positive-side current on the first line L1 and the negative-side current on the second line L2 are balanced is shifted leftward on the negative side. Thus, as the ammonia concentration is increased, the potential of the detection electrode 22 with respect to the reference electrode 23 is increased on the negative side. In other words, as the ammonia concentration is increased, the potential difference (mixed potential) ΔV between the detection electrode 22 and the reference electrode 23 is increased. Since the potential difference ΔV is increased as the ammonia concentration is increased, the ammonia concentration in the gas to be detected G can be detected by detecting the potential difference ΔV.

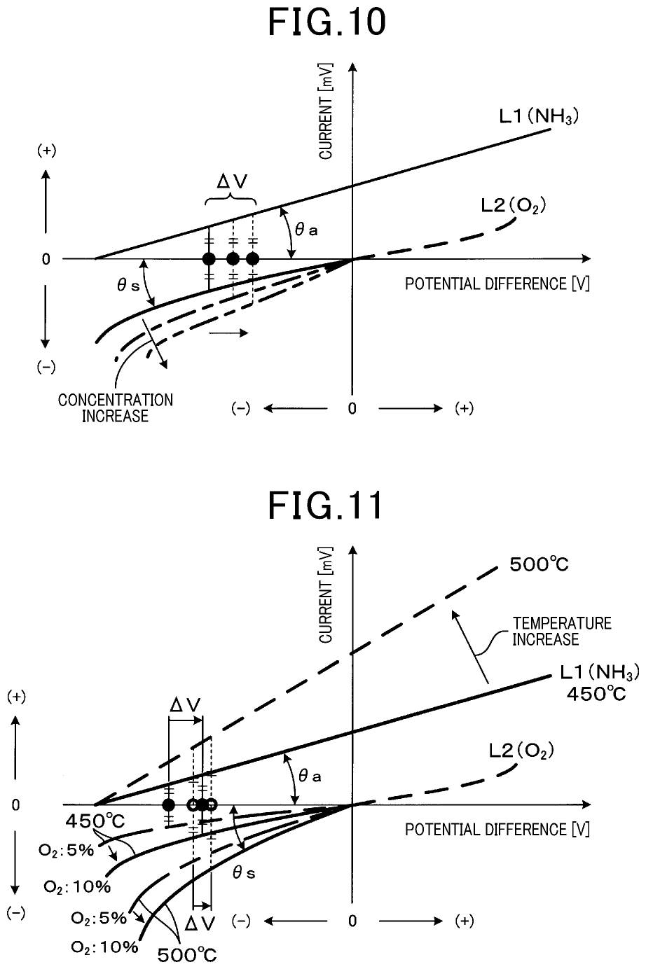

As shown in FIG. 10, if the oxygen concentration in the gas to be detected G is increased, the inclination θs of the second line L2, which represents the reduction reaction of oxygen, becomes steeper. In this case, the potential at which the positive-side current on the first line L1 and the negative-side current on the second line L2 are balanced shifts to a position closer to zero on the negative side. Thus, as the oxygen concentration is increased, the negative-side potential of the detection electrode 22 with respect to the reference electrode 23 is decreased. In other words, as the oxygen concentration is increased, the potential difference (mixed potential) ΔV between the detection electrode 22 and the reference electrode 23 is decreased. Thus, the detection accuracy of the ammonia concentration is improved by correcting the potential difference ΔV, or the ammonia concentration, to be increased as the oxygen concentration is increased.

(Temperature of Detection Electrode 22 and Potential Difference ΔV)

As shown in FIG. 11, if the temperature of the detection electrode 22 (and the ammonia element section 2) is increased, the inclination θa of the first line L1, which represents the oxidation reaction of ammonia, becomes steeper, and the inclination θs of the second line L2, which represents the reduction reaction of oxygen, also becomes steeper. FIG. 11 shows a case in which the temperature of the detection electrode 22 is changed from 450° C. to 500° C. If the temperature of the detection electrode 22 is increased, the oxidation current caused by the oxidation reaction of ammonia and the reduction current caused by the reduction reaction of oxygen are increased, and the potential difference (mixed potential) ΔV is decreased. If the temperature of the detection electrode 22 is decreased, a change opposite to the above occurs.

FIG. 11 also shows changes in the potential difference (mixed potential) ΔV when the oxygen concentration is changed from 5% (% by volume) to 10% for cases in which the temperature of the detection electrode 22 is 450° C. and is 500° C. If the oxygen concentration is increased, the potential difference (mixed potential) ΔV is decreased as described above. The change amount of the potential difference (mixed potential) ΔV decreased when the oxygen concentration is changed from 5% to 10% in a case in which the temperature of the detection electrode 22 is 450° C. is greater than the change amount of the potential difference (mixed potential) ΔV decreased when the oxygen concentration is changed from 5% to 10% in a case in which the temperature of the detection electrode 22 is 500° C.

In other words, the higher the temperature of the detection electrode 22, the smaller the change amount of the potential difference (mixed potential) ΔV when the oxygen concentration is changed. Based on this, the ammonia concentration calculator 52 decreases the correction amount of the ammonia concentration corresponding to the change amount of the oxygen concentration as the temperature of the detection electrode 22 is increased, that is, as the target control temperature of the energization control section 58 is increased.

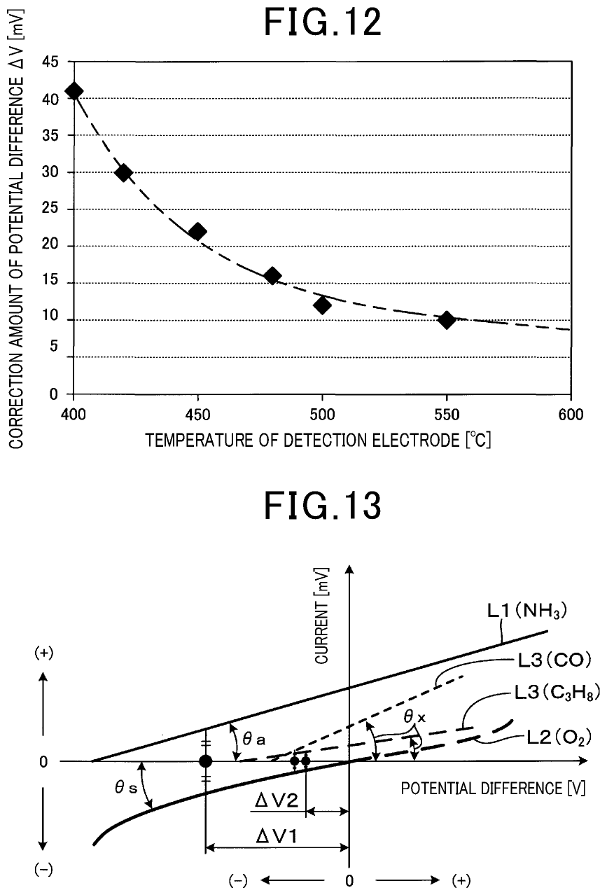

FIG. 12 shows how much the ammonia concentration was corrected by the ammonia concentration calculator 52 in accordance with the changes in the oxygen concentration when the oxygen concentration of the gas to be detected G was changed from 5% to 10% in a case in which the temperature of the detection electrode 22 is at a predetermined temperature between 400 to 600° C. The correction amount of the ammonia concentration is indicated as the correction amount [mV] of the potential difference ΔV. The correction amount of the potential difference ΔV in this case is a correction amount when the oxygen concentration is increased and is a correction amount that increases the potential difference ΔV.

In FIG. 12, the gas to be detected G supplied to the detection electrode 22 is changed from a state in which 5% (% by volume) of oxygen and 100 ppm of ammonia are contained in nitrogen to a state in which 10% of oxygen and 100 ppm of ammonia are contained in nitrogen. The gas to be detected G is supplied to the detection electrode 22 at a flow rate of 500 ml/min. The reference electrode 23 is brought into contact with the atmospheric air.

If the temperature of the detection electrode 22 is as low as about 400° C., the correction amount of the potential difference ΔV (ammonia concentration) when the oxygen concentration is changed by a predetermined amount (corresponding to the change amount of the oxygen concentration) is relatively large. If the temperature of the detection electrode 22 is as high as about 550° C., the correction amount of the potential difference ΔV (ammonia concentration) when the oxygen concentration is changed by a predetermined amount (corresponding to the change amount of the oxygen concentration) is relatively small. Note that, since the potential difference ΔV indicates the ammonia concentration, correcting the potential difference ΔV and correcting the ammonia concentration mean the same thing.

In the gas sensor 1 of the present embodiment, the energization control section 58 controls the temperature of the detection electrode 22 to a temperature within a temperature range of 350 to 600° C. If the detection electrode 22 is within the temperature range of 350 to 600° C., the accuracy in calculating the ammonia concentration by making a correction in accordance with the oxygen concentration is increased. In other words, the inventors found that the requirement that the temperature of the detection electrode 22 be within the temperature range of 350 to 600° C. is absolutely necessary for the mixed potential gas sensor 1, which obtains the ammonia concentration by making a correction in accordance with the oxygen concentration.

FIG. 13 shows the influence of other gases on the potential difference (mixed potential) ΔV if there are gases other than ammonia and oxygen, such as CO, NO, and hydrocarbon (such as C₃H₈), in the gas to be detected G. FIG. 13 shows a case in which the other gases are CO and C₃H₈. In FIG. 13, if there are oxygen, CO, and C₃H₈ in the gas to be detected G, the negative-side current on the second line L2, which represents the reduction reaction of oxygen, seeks to balance with the positive-side current on the first line L1, which represents the oxidation reaction of ammonia, and further seeks to balance with the negative-side current on third lines L3, which represent the reduction reaction of the other gases such as CO and C₃H₈.

Since the negative-side potential caused by CO and C₃H₈ is smaller than the negative-side potential caused by ammonia, a mixed potential ΔV2 at which the reduction reaction of oxygen and the oxidation reaction of CO and C₃H₈ are balanced is lower than the mixed potential ΔV1 at which the reduction reaction of oxygen and the oxidation reaction of ammonia are balanced (or is close to zero on the negative side). Thus, the mixed potential ΔV1, which represents the ammonia concentration, may be affected by the mixed potential ΔV2, which represents the concentration of the other gases, which may possibly result in deteriorating the detection accuracy of the mixed potential ΔV1. In other words, the mixed potential ΔV1 may possibly become a potential which is combined with the mixed potential ΔV2. Additionally, the temperature dependence differs between the mixed potential ΔV1 and the mixed potential ΔV2.

In FIG. 13, if the temperature of the detection electrode 22 is decreased, the inclination θa of the first line L1, which represents the oxidation reaction of ammonia, the inclination θs of the second line L2, which represents the reduction reaction of oxygen, and the inclination θx of the third lines L3, which represent the oxidation reaction of the other gases, are decreased. This causes the potential difference (mixed potential) ΔV1, which represents the ammonia concentration, to be easily affected by the other gases.

If the temperature of the detection electrode 22 is 350° C. or more, the oxidation catalyst performance of the detection electrode 22 with respect to ammonia is significantly higher than the oxidation catalyst performance of the detection electrode 22 with respect to the other gases. Thus, the mixed potential ΔV1 caused by the oxidation reaction of ammonia and the reduction reaction of oxygen is hardly affected by the mixed potential ΔV2 caused by the oxidation reaction of the other gases and the reduction reaction of oxygen.

If the temperature of the detection electrode 22 is less than 350° C., the difference between the oxidation catalyst performance of the detection electrode 22 with respect to ammonia and the oxidation catalyst performance of the detection electrode 22 with respect to the other gases is decreased. Thus, the mixed potential ΔV1 caused by the oxidation reaction of ammonia and the reduction reaction of oxygen is easily affected by the mixed potential ΔV2 caused by the oxidation reaction of the other gases and the reduction reaction of oxygen.

Furthermore, if the temperature of the detection electrode 22 exceeds 600° C., the inclination θa of the first line L1, which represents the oxidation reaction of ammonia, and the inclination θs of the second line L2, which represents the reduction reaction of oxygen, become extremely steep. Thus, the positive-side current representing the oxidation reaction of ammonia and the negative-side current representing the reduction reaction of oxygen are likely to be balanced in the vicinity of the origin where the potential difference ΔV is zero. For this reason, the mixed potential ΔV1, or the absolute value of the ammonia concentration, becomes small, which decreases the detection accuracy of the ammonia concentration.

Thus, controlling the temperature of the detection electrode 22 to be within the temperature range of 350 to 600° C. with the energization control section 58 enables maintaining the detection accuracy of the ammonia concentration after the oxygen correction to be high. Note that, if the temperature of the detection electrode 22 is within the range of 350 to 600° C., and ammonia is contained in the gas to be detected G by, for example, 10 ppm or more, it was verified that other gases, such as NOx, CO, and HC (hydrocarbon), which may be contained in the gas to be detected G, which is the exhaust gas in this embodiment, have an insignificant effect on the detection accuracy of the ammonia concentration.

(Oxygen Element Section 3)

As shown in FIGS. 1 and 6, to form the multi-gas sensor, the gas sensor 1 of the present embodiment includes the oxygen element section 3, a pumping section 53, a pump current detecting section 54, an oxygen concentration calculator 55, a NOx detecting section 56, and a NOx concentration calculator 57 in addition to the ammonia element section 2, the potential difference detecting section 51, the ammonia concentration calculator 52, the heater 4, and the energization control section 58. The heater 4, which heats the oxygen element section 3 and the ammonia element section 2, is laminated on the oxygen element section 3.

The oxygen element section 3 includes the second solid electrolyte 31, a gas chamber 35, a diffusion resistance section 351, a pump electrode 32, a NOx electrode 33, and other reference electrodes 34. The second solid electrolyte 31 is located to face the first solid electrolyte 21. The second solid electrolyte 31 is plate-shaped and is formed of a zirconia material that has the property of conducting oxygen ions at a predetermined temperature. The zirconia material is the same as that of the first solid electrolyte 21.

In the case in which the gas sensor 1 does not have the function of detecting NOx, the oxygen element section 3 does not necessarily have to include the NOx electrode 33, and the gas sensor 1 does not necessarily have to include the NOx detecting section 56 and the NOx concentration calculator 57.

As shown in FIGS. 1, 2, and 5, the gas chamber 35 is formed next to a third surface 311 of the second solid electrolyte 31. The gas chamber 35 is defined by a gas chamber insulating body 36. The gas chamber insulating body 36 is formed of a ceramic material such as alumina. The diffusion resistance section 351 is formed as a porous ceramic layer and introduces the gas to be detected G to the gas chamber 35 while restricting the diffusion speed.

The pump electrode 32 is on the third surface 311 and is accommodated in the gas chamber 35. The pump electrode 32 is exposed to the gas to be detected G in the gas chamber 35. The NOx electrode 33 is on the third surface 311 and is accommodated in the gas chamber 35. The NOx electrode 33 is exposed to the gas to be detected G the oxygen concentration of which has been adjusted by the pump electrode 32. The other reference electrodes 34 are located on a fourth surface 312 of the second solid electrolyte 31 reverse from the third surface 311.

The pump electrode 32 is formed of a noble metal material that exhibits catalytic activity for oxygen, but does not exhibit catalytic activity for NOx. The noble metal material of the pump electrode 32 may be made of an alloy of platinum and gold or material containing platinum and gold. The NOx electrode 33 is formed of a noble metal material that exhibits catalytic activity for NOx and oxygen. The noble metal material of the NOx electrode 33 may be made of an alloy of platinum and rhodium or material containing platinum and rhodium (Rh). The other reference electrodes 34 are formed of a noble metal material such as platinum that exhibits catalytic activity for oxygen. Furthermore, the pump electrode 32, the NOx electrode 33, and the other reference electrodes 34 may include a zirconia material that serves as common material used when the pump electrode 32, the NOx electrode 33, and the other reference electrodes 34 are sintered with the second solid electrolyte 31.

The other reference electrodes 34 of the present embodiment are located opposite to the pump electrode 32 with the second solid electrolyte 31 located in between and opposite to the NOx electrode 33 with the second solid electrolyte 31 located in between, respectively. Note that, the other reference electrodes 34 may be one electrode that is located opposite to the pump electrode 32 and the NOx electrode 33 with the second solid electrolyte 31 located in between.

As shown in FIGS. 1 to 3, the other reference electrodes 34, which are located on the fourth surface 312 of the second solid electrolyte 31, are exposed to the reference gas A, which is the atmospheric air in the present embodiment. The first solid electrolyte 21 and the second solid electrolyte 31 are laminated on one another with the duct insulating body 25, which defines the reference gas duct 24, located in between. The duct insulating body 25 is formed of a ceramic material such as alumina.

The reference gas duct 24 is formed in such a manner that the reference electrode 23 on the second surface 212 of the first solid electrolyte 21 and the other reference electrodes 34 on the fourth surface 312 of the second solid electrolyte 31 come into contact with the atmospheric air. The reference electrode 23 and the other reference electrodes 34 are accommodated in the reference gas duct 24. The reference gas duct 24 extends from the proximal end of the sensor element 10 to the position facing the gas chamber 35.

The reference gas A that is introduced in the proximal end cover of the gas sensor 1 is introduced into the reference gas duct 24 from the opening portion at the proximal end D2 of the reference gas duct 24. Since the sensor element 10 of the present embodiment includes the reference gas duct 24 between the first solid electrolyte 21 and the second solid electrolyte 31, the reference electrode 23 and the other reference electrodes 34 are brought into contact with the atmospheric air at the same time.

(Pumping Section 53, Pump Current Detecting Section 54 and Oxygen Concentration Calculator 55)

As shown in FIG. 1, the pumping section 53 applies a direct-current voltage across the pump electrode 32 and the corresponding one of the other reference electrodes 34 with the corresponding one of the other reference electrode 34 set as the positive side, so as to pump out the oxygen in the gas to be detected G in the gas chamber 35. When the direct-current voltage is applied across the pump electrode 32 and the corresponding one of the other reference electrodes 34, the oxygen in the gas to be detected G in the gas chamber 35 that comes into contact with the pump electrode 32 is converted to oxygen ions to pass through the second solid electrolyte 31 toward the corresponding one of the other reference electrode 34, and be discharged from the corresponding one of the other reference electrode 34 to the reference gas duct 24. Thus, the oxygen concentration in the gas chamber 35 is adjusted to the concentration appropriate for detecting NOx.

The pump current detecting section 54 detects the direct current that flows across the pump electrode 32 and the corresponding one of the other reference electrode 34. The oxygen concentration calculator 55 calculates the oxygen concentration in the gas to be detected G based on the direct current detected by the pump current detecting section 54. The pump current detecting section 54 detects the direct current proportional to the amount of oxygen discharged from the gas chamber 35 to the reference gas duct 24 by the pumping section 53.

Furthermore, the pumping section 53 discharges oxygen from the gas chamber 35 to the reference gas duct 24 until the oxygen concentration of the gas to be detected G in the gas chamber 35 becomes equal to a predetermined concentration. Thus, the oxygen concentration calculator 55 is capable of calculating the oxygen concentration of the gas to be detected G that reaches the ammonia element section 2 and the oxygen element section 3 by monitoring the direct current detected by the pump current detecting section 54.

The oxygen concentration calculated by the oxygen concentration calculator 55 is used as the oxygen concentration for correcting the ammonia concentration by the ammonia concentration calculator 52.

(NOx Detecting Section 56 and NOx Concentration Calculator 57)

As shown in FIG. 1, the NOx detecting section 56 applies a direct-current voltage across the NOx electrode 33 and the corresponding one of the other reference electrodes 34 with the corresponding one of the other reference electrodes 34 set as the positive side and detects the direct current that flows across the NOx electrode 33 and the corresponding one of the other reference electrodes 34. The NOx concentration calculator 57 calculates an uncorrected NOx concentration of the gas to be detected G based on the direct current detected by the NOx detecting section 56 and calculates a corrected NOx concentration by subtracting the ammonia concentration obtained by the ammonia concentration calculator 52 from the uncorrected NOx concentration. The NOx detecting section 56 detects ammonia besides NOx. For this reason, the NOx concentration calculator 57 obtains the actual detected amount of NOx by subtracting the detected amount of ammonia.

There are two kinds of NOx concentration obtained by the NOx concentration calculator 57. The NOx concentration based on the current that occurs in the NOx detecting section 56 is referred to as the uncorrected NOx concentration. The uncorrected NOx concentration includes the ammonia concentration of ammonia that reacts at the NOx electrode 33. The concentration obtained by subtracting the ammonia concentration obtained by the ammonia concentration calculator 52 from the uncorrected NOx concentration obtained by the NOx concentration calculator 57 is referred to as the corrected NOx concentration. The corrected NOx concentration indicates the NOx concentration that excludes the influence of ammonia. In comparing the ammonia concentration and the NOx concentration, the corrected NOx concentration is used.

The gas to be detected G after the oxygen concentration has been adjusted by the pump electrode 32 comes into contact with the NOx electrode 33. When the NOx detecting section 56 applies a direct-current voltage across the NOx electrode 33 and the corresponding one of the other reference electrode 34, NOx that comes into contact with the NOx electrode 33 is decomposed to nitrogen and oxygen. Oxygen is converted to oxygen ions to pass through the second solid electrolyte 31 toward the corresponding one of the other reference electrode 34, and be discharged from the corresponding one of the other reference electrode 34 to the reference gas duct 24. If ammonia reaches the NOx detecting section 56, NOx generated by the oxidation of ammonia is also decomposed to nitrogen and oxygen in the same manner. The NOx concentration calculator 57 calculates the uncorrected NOx concentration of the gas to be detected G that reaches the oxygen element section 3 by monitoring the direct current detected by the NOx detecting section 56 and calculates the NOx concentration as the corrected NOx concentration by subtracting the ammonia concentration from the uncorrected NOx concentration.

Since the gas sensor 1 is a multi-gas sensor that detects the oxygen concentration and the NOx concentration in addition to the ammonia concentration, the number of the gas sensor 1 to be located in the exhaust pipe 71 is reduced in detecting the ammonia concentration and the NOx concentration. Furthermore, the oxygen concentration is detected by the pump current detecting section 54 and the oxygen concentration calculator 55 by utilizing the pump electrode 32 and the pumping section 53 used for detecting the NOx concentration.

The pumping section 53, the pump current detecting section 54, and the NOx detecting section 56 are formed in the sensor control unit 5 using, for example, amplifiers. The oxygen concentration calculator 55 and the NOx concentration calculator 57 are formed in the sensor control unit 5 using, for example, computers.

In FIG. 1, the potential difference detecting section 51, the pumping section 53, the pump current detecting section 54, and the NOx detecting section 56 are illustrated separately from the sensor control unit 5 for convenience. Actually, these are built in the sensor control unit 5. Although not shown, each of the electrodes 22, 23, 32, 33, and 34 is provided with a lead for electrical connection that extends to the proximal end D2 of the sensor element 10 like a lead 412 of the heating member 41.

(Ammonia Concentration Calculator 52)

As shown in FIGS. 1 and 6, the ammonia concentration calculator 52 calculates the ammonia concentration of the gas to be detected G based on the oxygen concentration obtained by the oxygen concentration calculator 55 and the potential difference ΔV obtained by the potential difference detecting section 51.

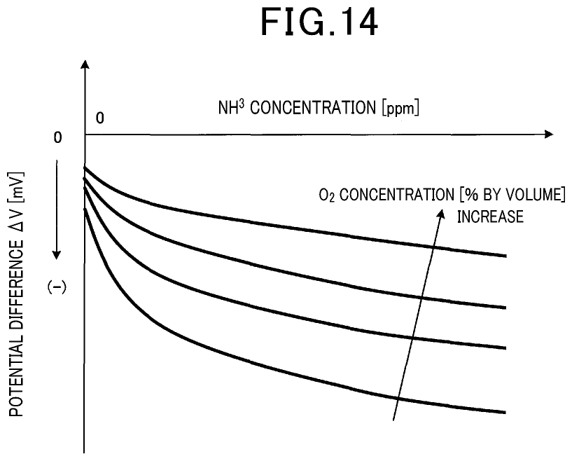

FIG. 14 shows that the potential difference (mixed potential) ΔV between the detection electrode 22 and the reference electrode 23 on the mixed-potential ammonia element section 2 obtained by the potential difference detecting section 51 is changed under the influence of the oxygen concentration. The potential difference (mixed potential) ΔV is detected in accordance with changes in the ammonia concentration of the gas to be detected G. As shown in FIG. 14, the higher the oxygen concentration, the smaller becomes the potential difference (mixed potential) ΔV detected by the potential difference detecting section 51 (detected at a position close to zero on the negative side). The reason for this is as described by the inclination θs shown in FIG. 10.

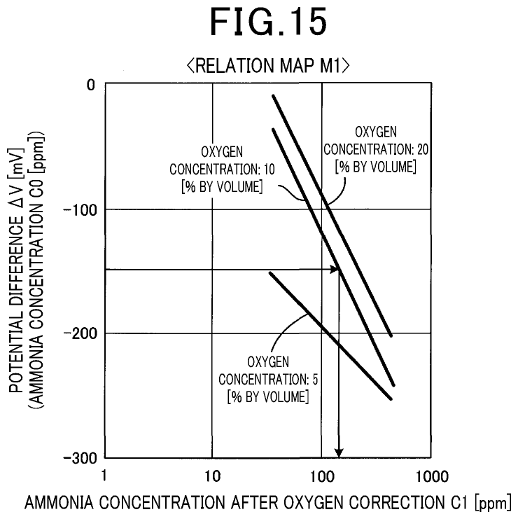

As shown in FIG. 15, the ammonia concentration calculator 52 of the present embodiment sets a relationship map M1, which shows the relationship between the potential difference ΔV obtained by the potential difference detecting section 51 and an ammonia concentration after oxygen correction C1, which has been corrected in accordance with the oxygen concentration, and the oxygen concentration of the gas to be detected G is set as parameters. The relationship map M1 is created as the relationship between the potential difference ΔV when the oxygen concentration is at a predetermined value (the ammonia concentration before oxygen correction CO) and the ammonia concentration after oxygen correction C1. The ammonia concentration calculator 52 verifies the oxygen concentration of the gas to be detected G and the potential difference ΔV obtained by the potential difference detecting section 51 against the relationship map M1 and calculates the ammonia concentration after oxygen correction C1 of the gas to be detected G.

More specifically, the ammonia concentration calculator 52 verifies the oxygen concentration obtained by the oxygen concentration calculator 55 and the potential difference ΔV obtained by the potential difference detecting section 51 against the oxygen concentration and the potential difference ΔV in the relationship map M1, respectively. The ammonia concentration after oxygen correction C1 at the potential difference ΔV is read from the relationship map M1. The ammonia concentration calculator 52 corrects the ammonia concentration after oxygen correction C1 to be higher as the oxygen concentration is increased. In this manner, as shown in FIG. 6, the ammonia concentration after oxygen correction C1 serves as an ammonia output concentration that has been corrected in accordance with the oxygen concentration and is output from the gas sensor 1. In the relationship map M1, the potential difference ΔV may be the ammonia concentration before oxygen correction CO.

FIG. 15 shows the relationship map M1 of the cases in which the oxygen concentration in the gas to be detected G is, for example, 5 [% by volume], 10 [% by volume], and 20 [% by volume]. Using the relationship map M1 facilitates correcting the ammonia concentration CO or the potential difference ΔV in accordance with the oxygen concentration. The relationship map M1 of the potential difference ΔV and the ammonia concentration after oxygen correction C1 is previously obtained by, for example, making prototypes and conducting experiments of the gas sensor 1.

Furthermore, the relationship map M1 of FIG. 15 may be set for different temperatures of the detection electrode 22. The ammonia concentration after oxygen correction C1 can be calculated in accordance with the oxygen concentration, the difference in the temperature of the detection electrode 22 being reflected. Alternatively, the ammonia concentration after oxygen correction C1 calculated from the relationship map M1 may be corrected using the temperature correction coefficient that is determined in accordance with the temperature of the detection electrode 22.

The potential difference detecting section 51 and the ammonia concentration calculator 52 are formed in the sensor control unit (SCU) 5, which is electrically connected to the gas sensor 1. The potential difference detecting section 51 is formed using, for example, an amplifier that measures the potential difference ΔV between the detection electrode 22 and the reference electrode 23. The ammonia concentration calculator 52 is formed using, for example, a computer. Furthermore, the sensor control unit 5 is connected to the engine control unit (ECU) 50 of the internal combustion engine 7 and is used by the engine control unit 50 in controlling the operation of, for example, the internal combustion engine 7 and the reducing agent supplying device 73.

In correcting the ammonia concentration in accordance with the oxygen concentration, the ammonia concentration calculator 52 can also correct the ammonia concentration taking into consideration the uncorrected NOx concentration or the corrected NOx concentration obtained by the NOx detecting section 56. The NOx electrode 33 on the oxygen element section 3 exhibits catalytic activity not only for NOx but also for ammonia. Therefore, the ammonia concentration can be detected as the uncorrected NOx concentration at the NOx electrode 33. Thus, the ammonia concentration calculator 52 can also correct the ammonia concentration obtained as the potential difference ΔV based on the oxygen concentration, the temperature of the detection electrode 22, and the NOx concentration.

(Heater 4 and Energization Control Section 58)

As shown in FIGS. 1 and 2, the heater 4 for heating the oxygen element section 3 and the ammonia element section 2 is laminated on the side of the second solid electrolyte 31 reverse from the side on which the first solid electrolyte 21 is laminated. In other words, the heater 4 is laminated on the side of the oxygen element section 3 reverse from the side on which the ammonia element section 2 is laminated.

The heater 4 includes the heating member 41, which generates heat by energization, and the heater insulating body 42, which embeds the heating member 41. The heater insulating body 42 is formed of a ceramic material such as alumina. The reference gas duct 24, in which the reference gas A is introduced, is formed between the ammonia element section 2 and the oxygen element section 3. The reference electrode 23 and the other reference electrodes 34 are accommodated in the reference gas duct 24.

As shown in FIGS. 1 to 3, the heating member 41 includes the heating section 411 and the lead 412, which is connected to the heating section 411. The heating section 411 is formed at a position facing the electrodes 22, 23, 32, 33, and 34 in a direction in which each solid electrolyte 21 and 31 and each insulating body 25, 36, and 42 are laminated (hereinafter, referred to as a laminating direction S). The energization control section 58 for energizing the heating member 41, is connected to the heating member 41. The energization amount of the heating member 41 by the energization control section 58 is adjusted by changing the voltage applied to the heating member 41. The energization control section 58 is formed by, for example, a drive circuit that applies a voltage performing a PWM (pulse-width modulation) control or the like, to the heating member 41. The energization control section 58 is formed in the sensor control unit 5.

The distance between the ammonia element section 2 and the heater 4 is greater than the distance between the oxygen element section 3 and the heater 4. Compared with the temperature to which the oxygen element section 3 is heated by the heater 4, the temperature to which the ammonia element section 2 is heated by the heater 4 is low. The pump electrode 32 and the NOx electrode 33 on the oxygen element section 3 are used within the operating temperature range of 600 to 900° C., and the detection electrode 22 of the ammonia element section 2 is used in the operating temperature range of 350 to 600° C. The lower limit operating temperature of the detection electrode 22 is 350° C., and the upper limit operating temperature is 600° C. The lower limit operating temperature of the detection electrode 22 may also be 400° C.

The temperature of the detection electrode 22 is controlled by heating of the heater 4 to a target temperature within the operating temperature range of 350 to 600° C. In controlling the temperature of the detection electrode 22 to the target control temperature, the energization control section 58 heats the NOx electrode 33 within the operating temperature range of 600 to 900° C. With this configuration, the energization control section 58 controls the heater 4 to heat the detection electrode 22 on the ammonia element section 2 and the NOx electrode 33 on the oxygen element section 3 to a temperature appropriate for detecting ammonia and detecting NOx, respectively.

Furthermore, since the reference gas duct 24 is formed between the oxygen element section 3 and the ammonia element section 2, the reference gas duct 24 serves as a heat-insulating layer in heating the oxygen element section 3 and the ammonia element section 2 by the heater 4. Thus, the temperature of the detection electrode 22 on the ammonia element section 2 is easily made lower than the temperature of the pump electrode 32 and the NOx electrode 33 on the oxygen element section 3. Furthermore, since the energization control section 58 controls the energizing, the temperature of the oxygen element section 3 and the ammonia element section 2 is controlled to a target temperature.

(Temperature Setting Unit 501)

As shown in FIG. 6, the gas sensor 1 includes a temperature setting section 501 for setting the target control temperature of the distal end region 221 and the proximal end region 222 of the detection electrode 22 controlled by the energization control section 58. The temperature setting section 501 sets the target control temperature of the detection electrode 22 to a specific temperature within the operating temperature range of 350 to 600° C. The target control temperature of the detection electrode 22 may be changed as required within the operating temperature range of 350 to 600° C.

(Positional Relationship Between Detection Electrode 22 and Heating Center P)

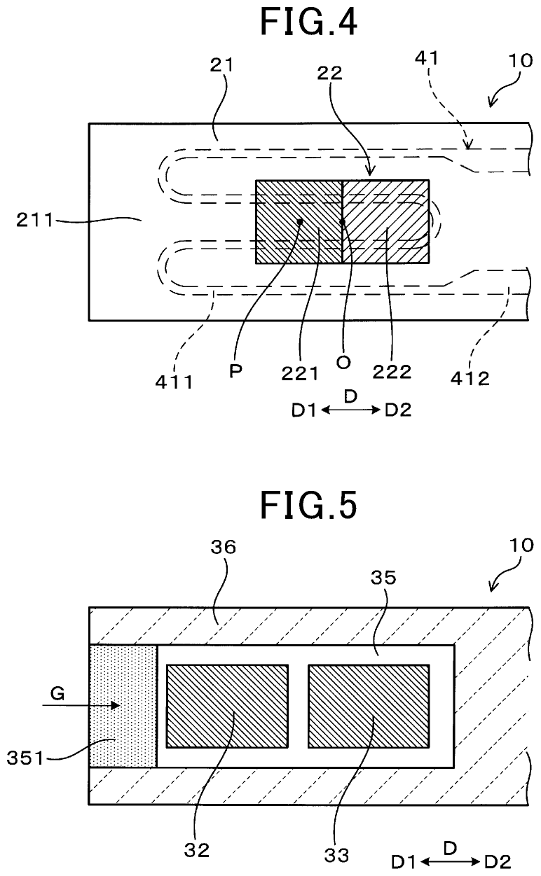

As shown in FIGS. 1 and 3, in the sensor element 10 of the gas sensor 1 of the present embodiment, the heating center P of the heating section 411 of the heating member 41 is located closer to the distal end D1 in the longitudinal direction D than the central position O of the detection electrode 22 in the longitudinal direction D. Furthermore, as shown in FIG. 3, the heating center P of the heating section 411 of the present embodiment is located closer to the distal end D1 in the longitudinal direction D than the distal end region 221 of the detection electrode 22. As shown in FIG. 4, the heating center P of the heating section 411 may be located at a position (overlapping position) facing the distal end region 221 of the detection electrode 22 in the laminating direction S.

In the detection electrode 22, the average temperature in the distal end region 221 in the longitudinal direction D is higher than the average temperature in the proximal end region 222 in the longitudinal direction D. The detection electrode 22 is partitioned at the central position O in the longitudinal direction D into the distal end region 221 and the proximal end region 222. The distal end region 221 is located to be closer to the distal end D1 than the proximal end region 222 is. The proximal end region 222 refers to the region of the detection electrode 22 excluding the distal end region 221, that is, the proximal end region 222 is located to be closer to the proximal end D2 than the distal end region 221 is.

The temperature distribution of the heating section 411 in the longitudinal direction D resulting from heat generation is a mound-shaped distribution in which the temperature is increased toward the heating center P of the heating section 411. Each section of the detection electrode 22 in the longitudinal direction D is heated so that the section closer to the heating center P of the heating section 411 is heated to a higher temperature.

The temperatures of the distal end region 221 and the proximal end region 222 are the surface temperature of the detection electrode 22. The average temperature in the distal end region 221 is the mean of the surface temperatures at multiple positions in the distal end region 221, and the average temperature in the proximal end region 222 is the mean of the surface temperatures at multiple positions in the proximal end region 222. The average temperature in the distal end region 221 may be, for example, the arithmetic mean obtained by measuring the surface temperatures at 5 to 100 positions in the distal end region 221. The average temperature in the proximal end region 222 may be, for example, the arithmetic mean obtained by measuring the surface temperatures at 5 to 100 positions in the proximal end region 222. The surface temperature of the detection electrode 22 may be measured by, for example, thermography, in which the temperature is measured in a non-contact manner using infrared radiation.

The temperatures to which the distal end region 221 and the proximal end region 222 of the detection electrode 22 are heated can be changed by varying, for example, the level of energizing current to the heating member 41 by the energization control section 58. Furthermore, the temperature difference between the average temperature in the distal end region 221 and the average temperature in the proximal end region 222 may be within the range of 10 to 60° C. The temperature difference may be adjusted by changing the position of the central position O of the detection electrode 22 in the longitudinal direction D with respect to the position of the heating center P of the heating section 411 in the longitudinal direction D. Additionally, the temperature difference may be adjusted by, for example, the level of energizing current to the heating member 41 by the energization control section 58.

In the present embodiment, the heating section 411 of the heating member 41 is located at a position facing the pump electrode 32 and the NOx electrode 33 in the laminating direction S to heat the pump electrode 32 and the NOx electrode 33 to an operating temperature of 600 to 900° C. In the meantime, the position of the detection electrode 22 in the longitudinal direction D with respect to the heating center P of the heating member 41 may be changed as required to achieve an operating temperature of 350 to 600° C. The further the central position O of the detection electrode 22 in the longitudinal direction D from the heating center P toward the distal end D1 or the proximal end D2, the greater becomes the temperature difference between the average temperature in the distal end region 221 and the average temperature in the proximal end region 222.

As the heating center P of the heating section 411 is brought closer to the central position O of the detection electrode 22 in the longitudinal direction D (the boundary position between the distal end region 221 and the proximal end region 222), the temperature difference is decreased. As the heating center P of the heating section 411 is brought further in the longitudinal direction D from the central position O of the detection electrode 22 in the longitudinal direction D, the temperature difference is increased. Since the temperature difference between the average temperature in the distal end region 221 and the average temperature in the proximal end region 222 is appropriately set in the range of 10 to 60° C., at least one of the temperatures of the distal end region 221 and the proximal end region 222 is maintained at the operating temperature of 350° C. or more in both the normal state and the transient state of the gas sensor 1 that has been subjected to a temperature change of the gas to be detected G.

Furthermore, in the detection electrode 22 of the present embodiment, the position of the heating center P of the heating section 411 in the longitudinal direction D with respect to the central position O of the detection electrode 22 in the longitudinal direction D is set so that the temperatures of all the sections of the distal end region 221 become greater than or equal to the temperatures of all the sections of the proximal end region 222. With this configuration, the temperature difference between the average temperature in the distal end region 221 and the average temperature in the proximal end region 222 is easily produced, and at least one of the distal end region 221 and the proximal end region 222 is easily maintained at an operating temperature of 350° C. or more.

In the normal state of the gas sensor 1, the average temperature in the distal end region 221 of the detection electrode 22 is in the range of 390 to 480° C. Additionally, in the normal state of the gas sensor 1, the average temperature in the proximal end region 222 of the detection electrode 22 is lower than the average temperature in the distal end region 221 and is in the range of 380 to 420° C.

(Operational Advantage)

In the gas sensor 1 of the present embodiment, the positional relationship between the detection electrode 22 and the heating section 411 of the heater 4 is designed in such a manner that the temperature of the detection electrode 22 differs between the distal end region 221 and the proximal end region 222 in the longitudinal direction D. More specifically, in the laminating direction S of the sensor element 10, the heating center P of the heating section 411 is arranged to face an offset point, the offset point is located to be closer to the distal end D1 of the detection electrode 22 in the longitudinal direction than the central position O of the detection electrode 22 in the longitudinal direction is. In other words, when the sensor element 10 is viewed from the laminating direction S of the solid electrolytes 21 and 31 and the insulating bodies 25, 36, and 42, the heating center P of the heating section 411 is arranged at an offset point which is located to be closer to the distal end D1 of the detection electrode 22 in the longitudinal direction than the central position O of the detection electrode 22 in the longitudinal direction is. The average temperature in the distal end region 221 of the detection electrode 22 in the longitudinal direction D is made higher than the average temperature in the proximal end region 222 of the detection electrode 22 in the longitudinal direction D.

When the ammonia sensor is constituted by the gas sensor 1, it is known that the sensitivity of the detection electrode 22 in detecting ammonia is increased as the heating temperature of the detection electrode 22 for detecting ammonia is decreased close to the lower limit operating temperature of 350° C. or 400° C. within the operating temperature range. Thus, the temperature to which the detection electrode 22 is heated by the heating member 41 is preferably set close to the lower limit operating temperature within the operating temperature range. However, if the temperature to which the detection electrode 22 is heated is set close to the lower limit operating temperature, in a case in which the temperature of the gas to be detected G, which is the exhaust gas in the present embodiment, is rapidly decreased in accordance with the operating condition of the internal combustion engine, the sensor element 10 is rapidly cooled by the exhaust gas, and the temperature of the detection electrode 22 may possibly become less than the lower limit operating temperature.

In the gas sensor 1 of the present embodiment, the temperature to which the detection electrode 22 is heated differs between the distal end region 221 and the proximal end region 222. The average temperature in the proximal end region 222 is set to a temperature close to the lower limit operating temperature within the operating temperature range. The average temperature in the distal end region 221 is set to a temperature higher than the average temperature in the proximal end region 222. With this configuration, in the normal state of the gas sensor 1, the sensitivity to ammonia is maintained high by the proximal end region 222 that is controlled to a temperature close to the lower limit operating temperature. Furthermore, in a transient state in which the temperature of the ammonia element section 2 is rapidly decreased due to, for example, the decrease in the temperature of the gas to be detected G or the increase in the flow rate, even if the average temperature in the proximal end region 222 becomes lower than the lower limit operating temperature, the average temperature in the distal end region 221 is brought to a temperature close to the lower limit operating temperature within the operating temperature range.

With this configuration, in both the normal state and the transient state, at least one of the distal end region 221 and the proximal end region 222 of the detection electrode 22 is maintained to a temperature close to the lower limit operating temperature within the operating temperature range. Consequently, the gas sensor 1 of the present embodiment accurately detects the concentration of ammonia as a specific gas component in the gas to be detected G in both the normal state and the transient state.

### Second Embodiment

The present embodiment shows the sensor element 10 in which the positional relationship between the detection electrode 22 and the heating center P differs from that of the first embodiment.

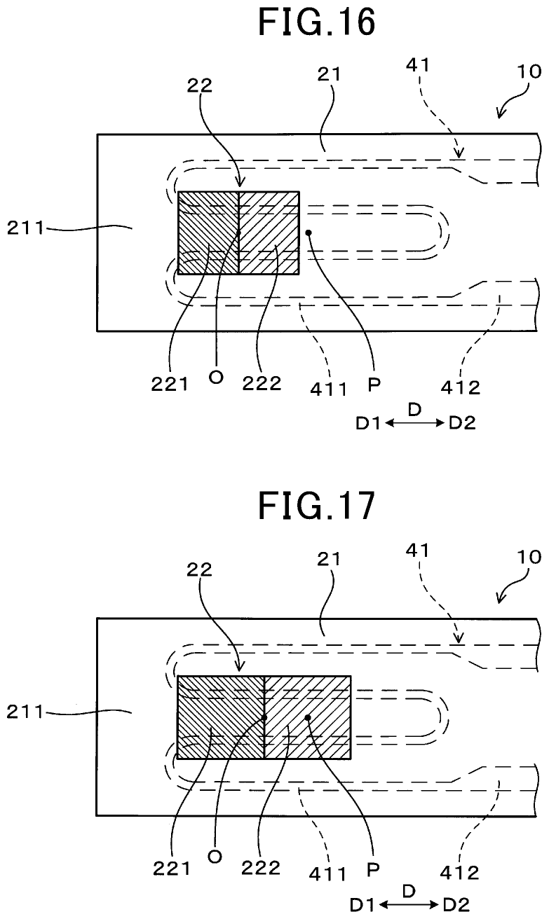

As shown in FIG. 16, in the sensor element 10 of the gas sensor 1 of the present embodiment, the heating center P of the heating section 411 of the heating member 41 is located at an offset point, the offset point being located to be closer to the proximal end D2 in the longitudinal direction D than the central position O of the detection electrode 22 in the longitudinal direction D is. Furthermore, the heating center P of the heating section 411 of the present embodiment is located at a point, the point being located to be closer to the proximal end D2 in the longitudinal direction D than the proximal end region 222 of the detection electrode 22 is. Note that, as shown in FIG. 17, the heating center P of the heating section 411 may be arranged to face (overlap with) the proximal end region 222 of the detection electrode 22 in the laminating direction S. In the detection electrode 22 of the present embodiment, the average temperature in the proximal end region 222 in the longitudinal direction D is higher than the average temperature in the distal end region 221 in the longitudinal direction D.

In the detection electrode 22 of the present embodiment, the position of the heating center P of the heating section 411 with respect to the central position O of the detection electrode 22 in the longitudinal direction D is set so that the temperatures of all the sections of the distal end region 221 become less than or equal to the temperatures of all the sections of the proximal end region 222. With this configuration, the temperature difference between the average temperature in the distal end region 221 and the average temperature in the proximal end region 222 is easily made, and at least one of the distal end region 221 and the proximal end region 222 is easily maintained within the operating temperature range of 350° C. or more.

In the normal state of the gas sensor 1, the average temperature in the proximal end region 222 of the detection electrode 22 is in the range of 390 to 480° C. Additionally, in the normal state of the gas sensor 1, the average temperature in the distal end region 221 of the detection electrode 22 is lower than the average temperature in the proximal end region 222 and is in the range of 380 to 420° C.

Other structures and the operational advantages of the gas sensor 1 of the present embodiment are the same as those of the first embodiment. In the present embodiment also, the same reference numerals as in the first embodiment denote the components that are identical to those in the first embodiment.

### Third Embodiment

The present embodiment shows the sensor element 10 that does not include the oxygen element section 3.

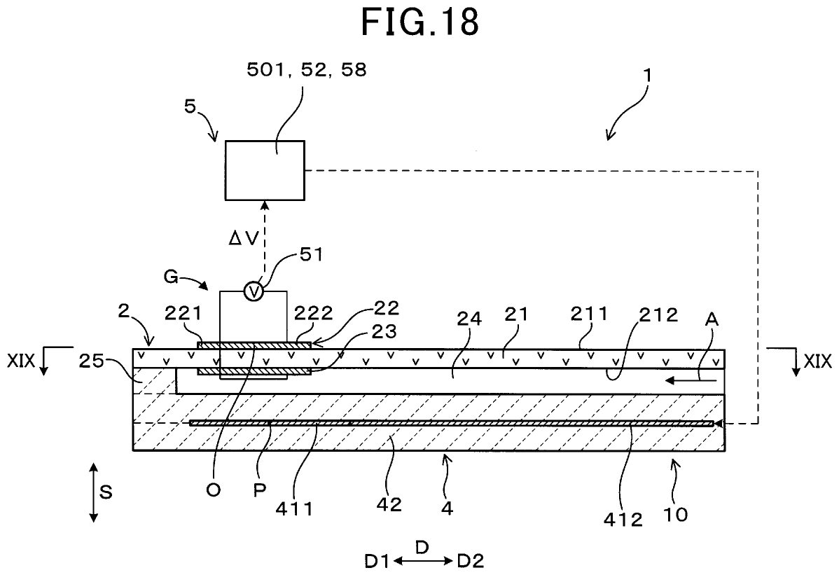

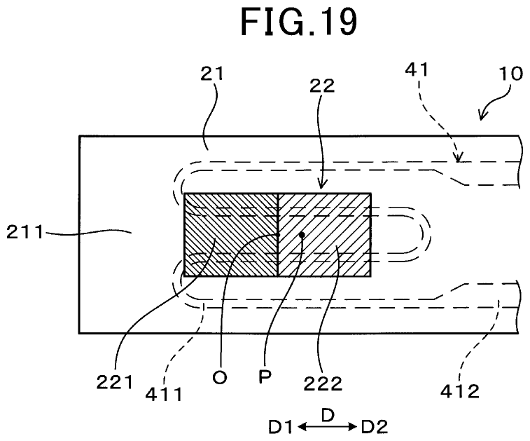

As shown in FIGS. 18 and 19, in a case in which the sensor element 10 detects only the ammonia concentration, the sensor element 10 includes the first solid electrolyte 21, on which the detection electrode 22 and the reference electrode 23 are located, the insulating body 25, in which the reference gas duct 24 is formed, and the insulating body 42, in which the heating member 41 is embedded. The first solid electrolyte 21, the insulating body 25, and the insulating body 42 are laminated on one another. The solid electrolyte of the present embodiment is the first solid electrolyte 21 provided with the detection electrode 22 and the reference electrode 23 are located.

The detection electrode 22 is located on the first surface 211, which is the outside surface of the first solid electrolyte 21 exposed to the gas to be detected G, and the reference electrode 23 is located in the reference gas duct 24. In this case also, the average temperature in the distal end region 221 of the detection electrode 22 is made different from the average temperature in the proximal end region 222. In this case, the oxygen concentration measured by other gas sensors may be used to obtain the ammonia concentration by the gas sensor 1.

Other structures and the operational advantages of the gas sensor 1 of the present embodiment are the same as those of the first and second embodiments. In the present embodiment also, the same reference numerals as in the first and second embodiments denote the components that are identical to those in the first and second embodiments.

### Fourth Embodiment

The present embodiment shows the sensor element 10 that does not include the oxygen element section 3 and the reference gas duct 24.

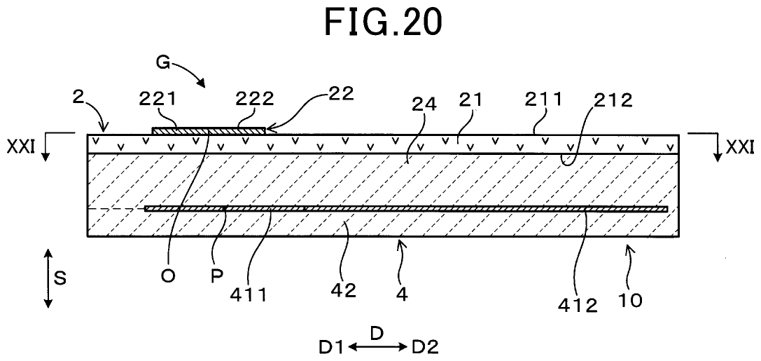

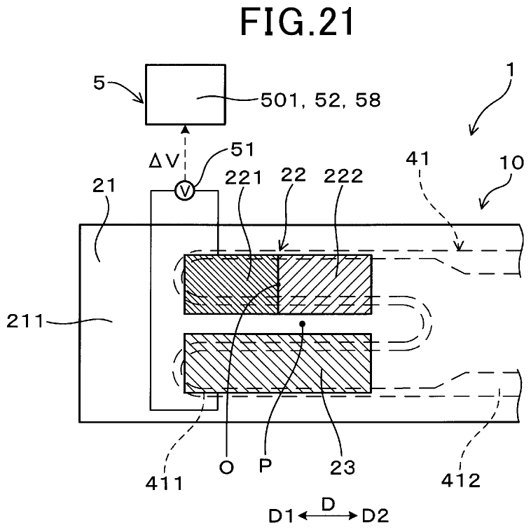

As shown in FIGS. 20 and 21, in a case in which the reference electrode 23 is not arranged in the reference gas duct 24, the detection electrode 22 and the reference electrode 23 are arranged on the first surface 211 of the first solid electrolyte 21. The first surface 211 constitutes the outside surface of the sensor element 10. In this case, the concentration of ammonia in the gas to be detected G is detected based on the difference between the detection electrode 22 and the reference electrode 23 in the catalytic activity for ammonia. In this case also, the average temperature in the distal end region 221 and the average temperature in the proximal end region 222 in the detection electrode 22 differ from each other.

Other structures and the operational advantages of the gas sensor 1 of the present embodiment are the same as those of the first and second embodiments. In the present embodiment also, the same reference numerals as in the first and second embodiments denote the components that are identical to those in the first and second embodiments.

<Verification Test 1>

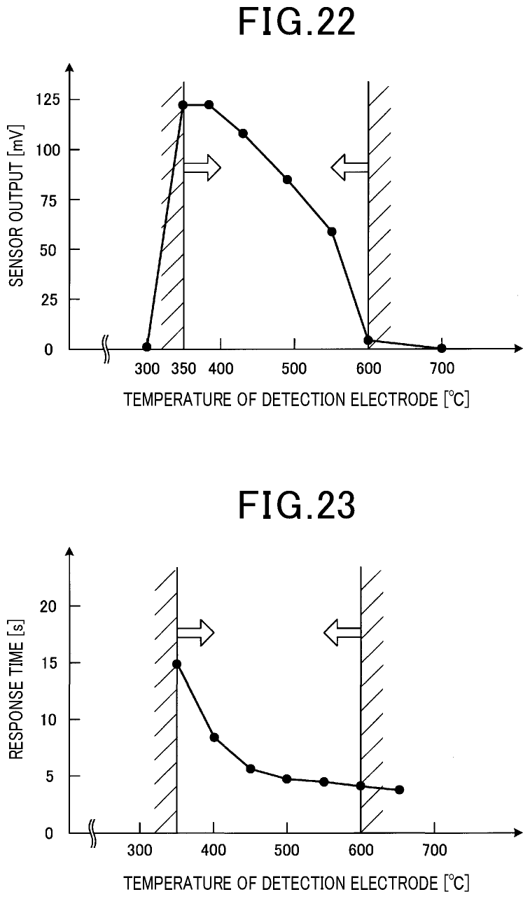

In Verification Test 1, the relationship between the temperature of the detection electrode 22 and the sensor output, and the relationship between the temperature of the detection electrode 22 and the response time of the detection electrode 22 was verified. FIG. 22 shows the result of the verification of the relationship between the temperature [° C.] of the detection electrode 22 and the sensor output [mV]. The temperature of the detection electrode 22 is represented by the temperature at the central position O of the detection electrode 22. The sensor output is represented by the mixed potential generated in the detection electrode 22 (the potential difference ΔV between the detection electrode 22 and the reference electrode 23). The detection electrode 22 was brought into contact with test gas, and the reference electrode 23 was brought into contact with the atmospheric air. The test gas contained 10% by volume of oxygen, 100 ppm of ammonia, and nitrogen occupying the remaining part. The temperature of the test gas was 250° C., and the flow rate of the test gas supplied to the detection electrode 22 was 3 L/min.

FIG. 22 shows that, when the temperature of the detection electrode 22 is in the range of 350 to 600° C., the sensor output is obtained, and this range is the operating temperature of the detection electrode 22. Furthermore, it is apparent that, the mixed potential on the detection electrode 22 becomes larger, when the temperature is lower as much as possible, in the operating temperature range of 350 to 600° C. In the meantime, it was verified that, if the temperature of the detection electrode 22 is less than 350° C., the oxygen ion conductivity of the solid electrolyte is decreased, and the mixed potential does not occur in the detection electrode 22. Furthermore, it was verified that, if the temperature of the detection electrode 22 exceeds 600° C., ammonia reacts and is eliminated on the detection electrode 22, and thus the mixed potential hardly occurs in the detection electrode 22.

FIG. 23 shows the result of the verification of the relationship between the temperature [° C.] of the detection electrode 22 and the response time [s] of the sensor output when the ammonia concentration of the test gas was changed. The temperature of the detection electrode 22 is represented by the temperature of the central position O of the detection electrode 22. The response time of the sensor output is represented by, when the concentration of ammonia of the test gas is switched from 100 ppm to 200 ppm, the time required for the sensor output to change from 10% output to 90% output of the output difference between the sensor output after being switched and the sensor output before being switched. Other conditions of the test gas are the same as those in the case of the sensor output test of FIG. 22.

FIG. 23 shows that the higher the temperature of the detection electrode 22, the shorter the response time. In the meantime, it is shown that if the temperature of the detection electrode 22 is decreased as low as about 350° C., the response time is increased.

With the result of the sensor output of FIG. 22 and the result of the response time of FIG. 23 considered, although the sensitivity (sensor output) of the detection electrode 22 is increased when the temperature of the detection electrode 22 is decreased to about 350° C. in the operating temperature range, the response of the detection electrode 22 deteriorates (response time is increased). Thus, the temperature of the detection electrode 22 is more preferably set in the range of 400 to 500° C. taking into consideration the balance between the sensor output and the response time.

<Verification Test 2>

In Verification Test 2, prototypes of the sensor element 10 were prepared including the detection electrode 22 on which the distal end region 221 and the proximal end region 222 were formed, and changes in the temperature of the distal end region 221 and the proximal end region 222 were observed. The sensor element 10 prepared as the prototype was a laminate of an insulating body made of alumina and the first solid electrolyte 21 made of yttria-stabilized zirconia (YSZ). The detection electrode 22 and the reference electrode 23 were arranged to face each other with the first solid electrolyte 21 located in between. The detection electrode 22 was constituted by a cermet electrode made of Au and YSZ, and the reference electrode 23 was constituted by a cermet electrode made of Pt and YSZ. Additionally, the reference gas duct 24, which accommodates the reference electrode 23, was formed in the insulating body.

Furthermore, the sensor element 10 of the present verification test is the same as the sensor element 10 shown in FIGS. 18 and 19 except that the position of the heater 4 with respect to the first solid electrolyte 21 is changeable. The temperature distribution of the surface of the distal end region 221 and the proximal end region 222 of the detection electrode 22 was measured by thermography, and the position of the detection electrode 22 with respect to the heater 4 was set and the energization amount to the heater 4 was controlled so that the temperature distribution obtained by the thermography achieves the desired distribution. The area of the detection electrode 22 and the reference electrode 23 was 10 mm² (2 mm×5 mm).

Furthermore, the detection electrode 22 was brought into contact with the test gas, and the reference electrode 23 was brought into contact with the atmospheric air. The test gas contained 10% by volume of oxygen, 100 ppm of ammonia, and nitrogen occupying the remaining part. The temperature of the test gas was 250° C., and the flow rate of the test gas supplied to the detection electrode 22 was 0.3 L/min in the normal state and was 30 L/min in the transient state.

In the normal state in which the test gas of 250° C. flows at 0.3 L/min, the heater 4 was controlled so that the average temperature in the distal end region 221 becomes about 440° C., and the average temperature in the proximal end region 222 becomes about 400° C. After a predetermined time had elapsed, the state was changed to the transient state in which the test gas flows at 30 L/min. The average temperature in the distal end region 221 and the average temperature in the proximal end region 222 were measured by thermography as the time elapses. Note that, after a predetermined time had elapsed from when the state was changed to the transient state, the average temperature in the distal end region 221 was restored to about 440° C., and the average temperature in the proximal end region 222 was restored to about 400° C. by the temperature control of the distal end region 221 and the proximal end region 222 of the detection electrode 22 performed by the heater 4.

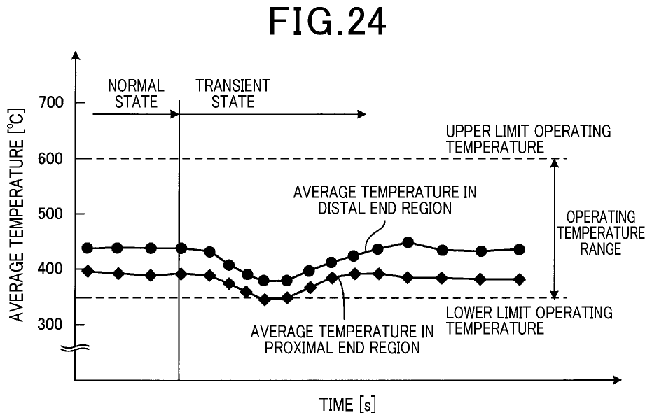

FIG. 24 shows the measurement result of the temperature in the present verification test. As shown in FIG. 24, the lower limit operating temperature of the detection electrode 22 is set to 350° C., and the upper limit operating temperature of the detection electrode 22 is set to 600° C. It is apparent that, after the state of the test gas is changed from the normal state to the transient state, the average temperature in the distal end region 221 and the average temperature in the proximal end region 222 are both decreased. The decrease in the average temperature was caused because the sensor element 10 of the prototype was cooled by the increase in the flow rate of the test gas.

When the average temperature was decreased, the average temperature in the proximal end region 222 was decreased to a temperature lower than the lower limit operating temperature of 350° C. It is inferred that, at this time, at least part of the proximal end region 222 was less than 350° C., and the proximal end region 222 was in a state that hinders exhibiting the oxygen ion conductivity for generating the sensor output. However, in this case also, the average temperature in the distal end region 221 was maintained at about 400° C. or more, and the distal end region 221 was maintained in a state that allows exhibiting the oxygen ion conductivity for generating the sensor output.

According to the test result, it was verified that the sensitivity of the detection electrode 22 is maintained by the entire detection electrode 22 even in the transient state in which the temperature of the sensor element 10 is rapidly decreased, by using the sensor element 10 including the detection electrode 22 in which the average temperature in the distal end region 221 differs from the average temperature in the proximal end region 222. Note that, in the case in which the average temperature in the proximal end region 222 is set higher than the average temperature in the distal end region 221, the same result as the present verification test was obtained.

<Verification Test 3>

In Verification Test 3, it was verified how much temperature difference is preferably between the average temperature in the distal end region 221 and the average temperature in the proximal end region 222 in the detection electrode 22. In this verification test, the distal end region 221 was set as a high-temperature region, and the proximal end region 222 was set as a low-temperature region the average temperature in which is lower than the average temperature in the high-temperature region. Furthermore, the sensor elements 10 of prototypes 1 to 8 were prepared that have a different temperature difference from each other in the range of 5 to 70° C.

When the state was changed from the normal state, in which the flow rate of the test gas supplied to the detection gas is 0.3 L/min, to the transient state, in which the flow rate of the test gas is 30 L/min, how much the sensor output of the gas sensor 1 (the potential difference ΔV between the detection electrode 22 and the reference electrode 23) was changed was measured, and the change was obtained as the change ratio [%] of the sensor output for each of the prototypes. The change ratio of the sensor output is obtained by the formula (X1−X2)/X1×100 [%] where the sensor output in the normal state is X1 [mV], and the sensor output in the transient state is X2 [mV].

How much variation of the sensor output occurred was checked for each of the prototypes as the stability of the sensor output. The stability was indicated as Excellent if the variation is small and Poor if the variation is large.

The result of the present verification test is shown in Table 1. In the table, it is judged whether the prototypes 1 to 8 are appropriate for the detection electrode 22, and it is indicated as Excellent if appropriate and Poor if not appropriate.

TABLE 1

| | Average | Average | | Change | | |
|---|---|---|---|---|---|---|
| | temperature in | temperature in | Temperature | ratio [%] | Stability of | |
| | low-temperature | high-temperature | difference | of sensor | sensor | |
| Prototype | region [° C.] | region [° C.] | [° C.] | output | output | Judgment |
| 1 | 400 | 405 | 5 | 55 | Excellent | Poor |
| 2 | | 410 | 10 | 20 | Excellent | Excellent |
| 3 | | 415 | 15 | 15 | Excellent | Excellent |
| 4 | | 420 | 20 | 11 | Excellent | Excellent |
| 5 | | 430 | 30 | 11 | Excellent | Excellent |
| 6 | | 450 | 50 | 8 | Excellent | Excellent |
| 7 | | 460 | 60 | 5 | Excellent | Excellent |
| 8 | | 470 | 70 | 4 | Poor | Poor |

For the prototype 1 with the temperature difference of 5° C., the change ratio of the sensor output was as large as 55%, and the judgment was Poor. For the prototype 8 with the temperature difference of 70° C., the stability of the sensor output was Poor, and the judgment was Poor. In the meantime, the prototypes 2 to 7 with the temperature difference of 10 to 60° C., the change ratio of the sensor output was small, and the stability of the sensor output was satisfactory, so that the judgment was Excellent. As a result, it was found that the temperature difference between the average temperature in the distal end region 221 and the average temperature in the proximal end region 222 in the detection electrode 22 is preferably in the range of 10 to 60° C.

The present disclosure is not limited to the above embodiments and may be modified without departing from the scope of the disclosure. The present disclosure embraces various modifications and deformations that come within the range of equivalency. Furthermore, various combinations and forms of components imaginable from the present disclosure are included in the technical ideas obtainable from the present disclosure.

What is claimed is:

1. A gas sensor comprising:
a detection element section that has an elongated shape in a longitudinal direction, and includes a solid electrolyte with oxygen-ion conductivity, a detection electrode which is located on a surface of the solid electrolyte and is exposed to gas to be detected, and a reference electrode located on the surface of the solid electrolyte;
a heater that includes a heating section that generates heat by energization, the heater being configured to heat the solid electrolyte, the detection electrode, and the reference electrode based on the heat generated by the heating section; and
a potential difference detecting section that detects a potential difference between the detection electrode and the reference electrode, the potential difference being caused as a mixed-potential between the detection electrode and the reference electrode when an electrochemical reduction reaction of oxygen contained in the gas to be detected and an electrochemical oxidation reaction of ammonia contained in the gas to be detected are balanced in the detection electrode, wherein
the detection electrode has a distal end, a proximal end, and a central position in the longitudinal direction;
the detection electrode is partitioned at the central position in the longitudinal direction into a distal end region and a proximal end region, the distal end region being located to be closer to the distal end than the proximal end region is, the proximal end region being located to be closer to the proximal end than the distal end region is; and
the heating section has a heating center arranged to face an offset point,
the offset point being located to be closer to one of the distal end and the proximal end of the detection electrode than the central position is, the heating center arranged to face the offset point causing a first average temperature in the distal end region of the detection electrode in the longitudinal direction to differ from a second average temperature in the proximal end region of the detection electrode in the longitudinal direction.

2. The gas sensor according to claim 1, wherein
the offset point is one of a first point and a second point, the first point being located within the distal end region of the detection electrode, the second point being located to be closer to the distal end than the distal end region is; and
in a normal state of the gas sensor, a first average temperature in the distal end region of the detection electrode is in a range of 390 to 480° C., a second average temperature in the proximal end region of the detection electrode is lower than the first average temperature in the distal end region of the detection electrode and is in a range of 380 to 420° C.

3. The gas sensor according to claim 1, wherein
the offset point is one of a first point and a second point, the first point being located within the proximal end region of the detection electrode, the second point being located to be closer to the proximal end than the proximal end region is; and
in a normal state of the gas sensor a second average temperature in the proximal end region of the detection electrode is in a range of 390 to 480° C., a first average temperature in the distal end region of the detection electrode is lower than the second average temperature in the proximal end region of the detection electrode and is in a range of 380 to 420° C.

4. The gas sensor according to claim 1, wherein a difference between the first average temperature in the distal end region and the second average temperature in the proximal end region is in a range of 10 to 60° C.

5. The gas sensor according to claim 1, wherein
the solid electrolyte is plate-shaped,
a plate-like insulating body is laminated on the solid electrolyte,
the heater includes a heating member embedded in the insulating body, the heating section being formed in the heating member,
a reference gas duct is formed in the insulating body, the reference gas duct accommodating the reference electrode,
the solid electrolyte has an outer surface that is exposed to the gas to be detected, and the detection electrode is located on the outer surface of the solid electrolyte.
